(19) United States
(12) Patent Application Publication
(10) Pub. No.: US 2019/0124153 A1
(43) Pub. Date: Apr. 25, 2019

(54) DATA PROCESSING DEVICE AND METHOD FOR DATA SHARING AMONG MULTIPLE USERS, AND COMPUTER PROGRAM

(71) Applicant: CENTER OF HUMAN-CENTERED INTERACTION FOR COEXISTENCE, Seoul (KR)

(72) Inventors: Sang Hun Nam, Seoul (KR); Joung Huem Kwon, Seoul (KR); Eunseok Choi, Seoul (KR); Bum Jae You, Seoul (KR)

(73) Assignee: CENTER OF HUMAN-CENTERED INTERACTION FOR COEXISTENCE, Seoul (KR)

(21) Appl. No.: 16/306,931

(22) PCT Filed: Apr. 24, 2017
(86) PCT No.: PCT/KR2017/004338

§ 371 Date: Dec. 4, 2018

(30) Foreign Application Priority Data
Jun. 16, 2016 (KR) 10-2016-0075185

(51) Int. Cl. H04L 29/08

(52) U.S. Cl. CPC H04L 67/1097; H04L 67/1095

(57) ABSTRACT

The present invention relates to a data processing device, method, and computer program for data sharing among multiple users. The device includes a sensor module collecting data by using at least one of a camera sensor, a distance sensor, a microphone array, a motion capture sensor, an environment scanner, and a haptic device; a memory module storing and controlling the data collected by the sensor module; and a network module transmitting the data stored in the memory module to a remote location, or receiving predetermined data from the remote location, wherein the memory module stores the stored data and the predetermined data as data in a standardized format according to data features.

### TECHNICAL FIELD

The present invention relates generally to a data processing device, method, and computer program for data sharing among multiple users. More particularly, the present invention relates to a data processing device, method, and computer program for data sharing among multiple users, by which it is possible to transmit and share data in real time among multiple users who cooperate with each other remotely.

### BACKGROUND ART

In order to develop applications based on hardware using sensors, software research has been done in various areas. For example, there is developed software which uses a signal input through each of sensors such as a temperature sensor, a motion sensor, and the like, and automatically generates an appropriate output signal corresponding thereto. In particular, for software that automatically generates an appropriate output signal corresponding to a given input signal, a large amount of data is required, and therefore, many experiments and studies for data collection have been conducted.

On the other hand, when a large number of developers gather in a specific place to develop software, there are advantages that the time for software development can be shortened and the target software can be clearly implemented. However, there are problems that, when many developers are positioned remotely, it is difficult to share data collected by each developer, and when the input devices, output devices, and network devices used by each developer are different from each other, it is necessary to know all of the codec, synchronization, network, etc. used by each of developers who are positioned remotely in order to analyze data collected by developers who are positioned remotely.

### DISCLOSURE

### Technical Problem

It is an object of the present invention to provide a data processing device, method, and computer program for data sharing among multiple users, by which it is possible to store and compress the collected data, and calculate the update data in order to transmit and share data in real time among multiple users who are positioned remotely.

### Technical Solution

In order to achieve the object, a data processing device according to the present invention includes a sensor module collecting data by using at least one of a camera sensor, a distance sensor, a microphone array, a motion capture sensor, an environment scanner, and a haptic device, a memory module storing and controlling the data collected by the sensor module, and a network module transmitting the data stored in the memory module to a remote location, or receiving predetermined data from the remote location, wherein the memory module stores the stored data and the predetermined data as data in a standardized format according to data features.

In addition, in order to achieve the object, a data processing method according to the present invention includes collecting data by using at least one of a camera sensor, a distance sensor, a microphone array, a motion capture sensor, an environment scanner, and a haptic device, storing the collected data in a memory module; transmitting the stored data to a remote location or receiving predetermined data from the remote location, through a network module, and storing the received predetermined data in the memory module, wherein the collected data and the predetermined data are stored as data in a standardized format according to data features.

### Advantageous Effects

According to the present invention, it is possible to share the collected data among multiple users who cooperate with each other remotely. Therefore, it is possible to collect a large amount of initial data for developing software, and to minimize errors that may occur in the process of collecting data.

In addition, according to the present invention, since data received from a remote user is stored in the memory module in the form of standardized data, the user can conveniently use the received data without the need to consider the codec, synchronization, or network.

Further, according to the present invention, since the collected data can be shared among multiple users and the generated update data can be shared on the basis of the collected data, errors that may occur in the process of software development can be corrected and minimized.

Therefore, according to the present invention, it is possible to conveniently and efficiently develop software that is to be implemented by multiple users by providing an environment in which multiple users transmit and share data in real time regardless of the format of the collected data.

### DESCRIPTION OF DRAWINGS

FIG. 1 is a schematic diagram illustrating a data processing device for software development among multiple users.

FIG. 2 is a configuration diagram illustrating a data processing device according to the present invention.

FIG. 3 is a view illustrating a data processing method of storing the collected data according to the present invention.

FIG. 4 is a view illustrating a data processing method of transmitting and receiving data according to the present invention.

FIG. 5 is a view illustrating a data processing method of updating data according to the present invention.

### MODE FOR INVENTION

The present invention relates to a data processing device, method, and computer program for software development among multiple users, by which it is possible to provide an environment in which software may be developed more conveniently and effectively by transmitting and sharing data in real time among multiple users who cooperate with each other remotely.

Hereinafter, an embodiment of the present invention will be described in detail with reference to the drawings.

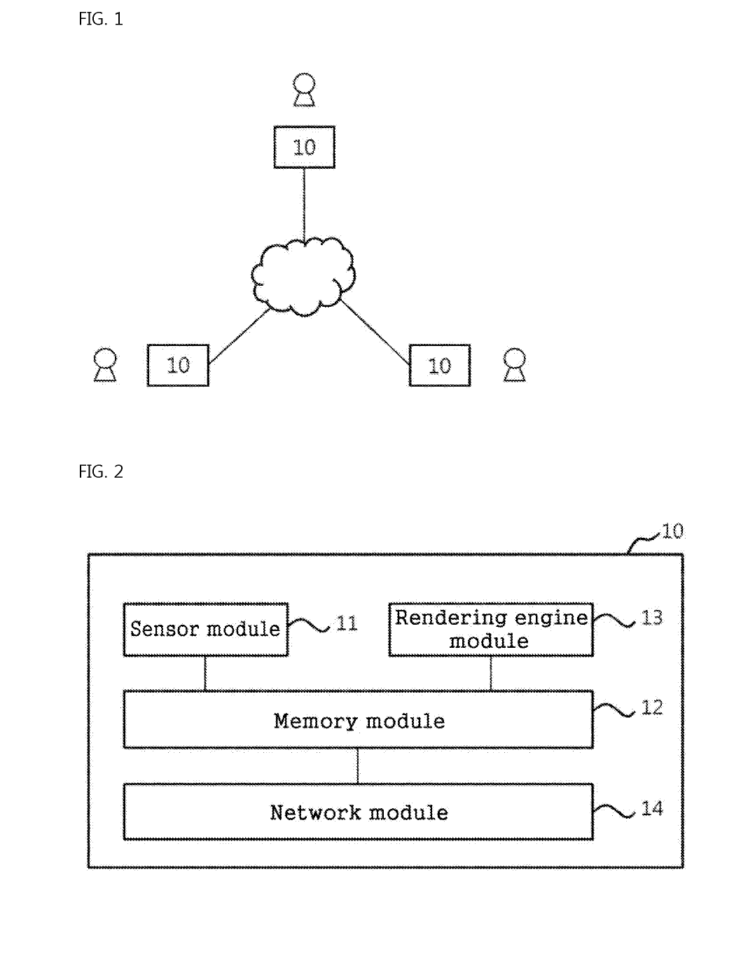

FIG. 1 is a schematic diagram illustrating a data processing device for software development among multiple users.

First, each of a user, a remote user (hereinafter, referred to as a second user), and another remote user (hereinafter referred to as a third user) collects data through cooperation with each other and uses the data processing device, method, or computer program according to the present invention in order to share the collected data.

For example, a data processing device 10 is configured in equipment, a computer, an integrated control device, and the like that are used by each of the user, the second user, and the third user.

Next, the user may collect the data and then use the collected data or transmit the collected data to the second user or the third user, or store or use the calculated update data on the basis of the predetermined data and transmit the update data to the second user or the third user. Further, the user may receive data collected by the second user or the third user, and receive the update data calculated by the data processing device provided in the second user or the third user.

Since the data processing device 10 is provided for each user, the second user and the third user may also transmit and receive data in the same manner as described above. By providing the data processing device 10 according to the present invention, it is possible to transmit and share the data in real time among multiple users who cooperate with each other remotely.

The data processing device provided for each user side will be described in more detail in FIG. 2.

FIG. 2 is a configuration diagram illustrating a data processing device according to the present invention. As shown in FIG. 2, the data processing device 10 may include a sensor module 11, a memory module 12, a rendering engine module 13, and a network module 14.

The sensor module 11, as a module for collecting data sensed by various sensors, collects data that is input via, for example, a camera sensor, a distance sensor, a depth sensor, a microphone array, a motion capture sensor, an environment scanner, a haptic device, and the like.

The memory module 12 stores data collected by the sensor module 11. The user may access the data stored in the memory module 12 and freely use the data.

Also, the memory module 12 may compress and store data. For example, when the collected data includes an image or a voice, the data collected using the compression codec may be compressed to reduce the data size. The compression codec may be set differently according to users. The compressed data may be transmitted to a remote user through the network module 14 and may be decompressed by a memory module provided for the remote user, whereby the remote user may use the collected data by a certain user without the need to consider the compression codec used by the certain user.

In addition, when the data collected by the remote user is received in the form of compressed data, the memory module 12 may decompress the received compressed data and store the decompressed data in the memory module 12. Accordingly, the memory module 12 may decompress the compressed data and store the decompressed data in a standardized format regardless of the compression codec used in the received compressed data.

Here, the data in the standardized format refers to data obtained by converting data collected by the user and data collected by the remote user into data in a certain format according to data features. There is no restriction on the format of data stored in the memory module 12, and the format may follow standardized international standards for data. For example, when data collected by the remote user includes a video signal, the video signal may be converted into a video signal of a certain standard and then stored. When the video signal includes a voice signal, the voice signal may be converted into a voice signal of a certain standard and then stored. Therefore, the data may be stored in the memory module 12 regardless of synchronization, codec or the like used by the user and the remote user and then freely used in the rendering engine module 13.

Also, the memory module 12 may store update data calculated by the rendering engine module 13, and may compress and store the update data.

In addition, the memory module 12 may store update data received from the remote user via the network module 14. When the update data is received via the network module 14, the memory module 12 may overwrite the stored data with the update data.

Also, the memory module 12 may predict the update data received from the remote user through the network module 14 and then store the data. When the update data is received through the network module 14, the memory module 12 may update the prediction data periodically by applying the update data to new prediction algorithm. For example, future data is estimated on the basis of the previous data and the estimated data is overwritten with the update data in order to solve a problem of delay when physical engines are applied at the same time, whereby the rendering engine module 13 renders the data acquired by resolving the problem of delay and outputs the rendering data.

The rendering engine module 13, as a device for outputting data as video, audio, or text to an output device (not shown) such as a video output device, a voice output device, etc. that are used by a user, includes a graphic rendering engine, audio rendering engine, physics engine, a haptic rendering engine, an avatar engine, an engine, a sensory engine, an artificial intelligence engine, and the like. The rendering engine module 13 may output the data collected by the user or renders the data collected by the remote user according to an output device (not shown) and then outputs the rendering data.

In addition, the rendering engine module 13 may calculate update data on the basis of the data stored in the memory module 12. For example, the physical engine included in the rendering engine module 13 may calculate position and motion data or collision data of objects. Also, the avatar engine may calculate partial position and motion data of an avatar, and the artificial intelligence engine may calculate the position, motion, and notification data of artificial intelligence objects. The update data calculated by the rendering engine module 13 may be stored in the memory module 12 in real time and may be automatically transmitted to the remote user via the network module 14.

Also, when update data is received from the remote user via the network module 14, the memory module 12 may overwrite the previously stored data with the update data, and the rendering engine module 13 may send the update data to an output device (not shown).

The network module 14 is a module that transmits data stored in the memory module 12 to the remote user or receives data collected by the remote user. The data stored in the memory module 12 may be data collected by the sensor module 11, compressed data obtained by compressing the collected data, update data calculated by the rendering engine module 13, or data previously received from another user positioned remotely. The data collected by the remote user may be data collected by a sensor module positioned remotely, compressed data compressed by a memory module positioned remotely, or update data calculated by a rendering engine module positioned remotely.

In addition, when the network module 14 receives data collected by the remote user, the network module 14 may perform synchronization on the received data and store the received data in the memory module 12. For example, when the received data includes a video signal, video synchronization is performed, and when the received data includes an audio signal, audio synchronization is performed. When both the video signal and the audio signal are included, video synchronization and audio synchronization are performed. Accordingly, with respect to the data received via the network module 14, the user may use the data stored in the memory module 12 without the need to consider network or synchronization.

As described above, the present invention provides a data processing device capable of transmitting and sharing the collected data in real time among multiple users who cooperate with each other remotely, in which the user may use the data collected by the remote user without the need to consider a compression codec, synchronization, network, and the like that are used by the remote user.

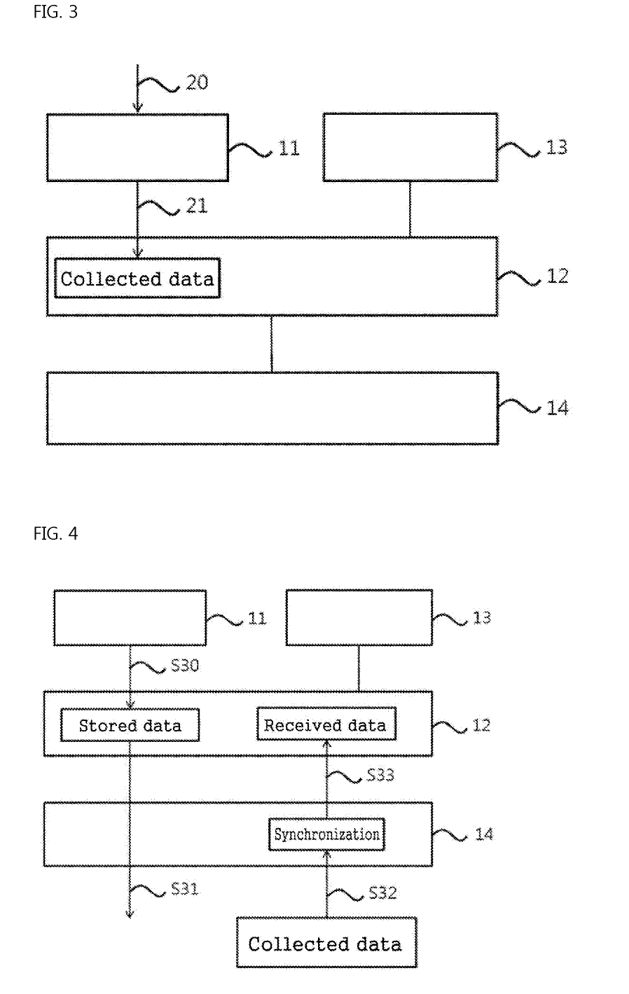

FIG. 3 is a view illustrating a data processing method of storing the collected data according to the invention. When data is collected through a camera sensor, a distance sensor, a depth sensor, a microphone array, a motion collection sensor, an environmental scanner, a haptic device, etc. that are included in the sensor module 11 (S20), the collected data is stored in the memory module 12 (S21). The data stored in the memory module 12 may be freely accessed and used by the user.

For example, when a video signal is collected through a camera sensor, the collected original video is stored in the memory module 12. The stored original video may be compressed through the H.264 compression codec and stored as the compressed data in the memory module 12. Also, the depth data obtained by the depth sensor is also stored in the memory module 12. When the user wishes to use the image processing algorithm that detects the fingertips, the original video stored in the memory module 12 may be called and then used.

FIG. 4 is a view illustrating a data processing method of transmitting and receiving data according to the present invention. Data collected by the sensor module 11 or data previously received from another remote user are stored in the memory module 12 (S30). The data collected by the sensor module 11 may be stored as compressed data. The data stored in the memory module 12 is transmitted to a network module of a data processing device provided at a remote location, via the network module 14 (S31).

When the data collected by the remote user is received through the network module 14, the network module 14 performs a synchronization operation on the received data (S32). The data with the synchronization operation thereon being completed is stored in the memory module 12 (S33). When data collected by the remote user is received via the network module 14 in the form of compressed data, the memory module 12 may decompress the received compressed data and store the decompressed data in the memory module 12. Therefore, regardless of the compression codec used in the compressed data, the user may use the data stored in the memory module 12 in a decompressed and standardized format.

For example, the network module 14 performs synchronization operations on data including video signal, depth data, and object location, and stores the synchronized data in the memory module 12. The rendering engine module 13 may convert the data collected by the remote user into a stereoscopic video using the video signal and the depth data stored in the memory module 12.

According to the present invention, the memory module 12 may store data collected by the user and data collected by the remote user as standardized data in a certain format according to data features, whereby the user may access and use the data stored in the memory module 12 regardless of the format of the data received through the network module 14.

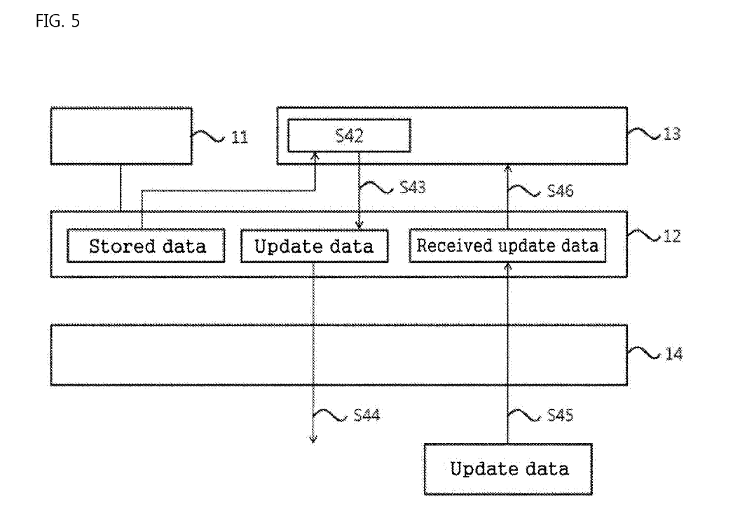

FIG. 5 is a view illustrating a data processing method of updating data according to the present invention.

The rendering engine module 13 calculates update data on the basis of the data stored in the memory module 12 (S42). Here, the data stored in the memory module 12 includes all the data collected by the user and the data collected by the remote user. For example, the update data may be calculated on the basis of the data collected by the user, the update data previously calculated on the basis of the data collected by the user, the data or the update data received from the remote user, and the like. The calculated update data is stored in the memory module 12 in real time (S43), and is automatically transmitted to the remote user through the network module 14 (S44).

For example, the physics engine included in the rendering engine module 13 may calculate position data of an object using the depth data stored in the memory module 12. When the position data is changed according to the motion of the object, the physical engine calculates the position of new object to calculate the update data, and the calculated data may be periodically transmitted to the remote user through the network module 14

When update data calculated by a data processing device provided at a remote location is received through the network module 14, the memory module 12 may overwrite the stored data with the received data (S45). Here, the update data may be stored in addition to the pre-stored date or may be stored instead of the pre-stored data. The rendering engine module 13 may calculate new update data on the basis of the update data or may output the update data to an output device (not shown) used by the user (S46).

According to the present invention, the memory module 12 may store the data, the update data, and the update data received from the remote location as standardized data in a certain format according to data features.

The data processing method according to the present invention may be implemented as a code readable by a processor in a recording medium readable by a processor provided in equipment, computer, integrated control device, etc. used by a user. The recording medium readable by the processor includes all kinds of recording devices in which data that may be read by the processor is stored. The recording medium readable by the processor include, for example, a ROM, a RAM, a CD-ROM, a magnetic tape, a floppy disk, an optical data storage device and the like, and also includes one implemented in the form of a carrier wave, i. e., transmission over the Internet. In addition, the recording medium readable by the processor may be distributed over computer systems connected by the network so that code readable by the processor in a distributed fashion may be stored and executed.

As described above, according to the present invention, when a data processing device or a data processing computer program is provided in each of multiple users who are positioned remotely, data collected by each user can be transmitted to a remote user, and the data in a standardized format can be stored in the memory module without the need to consider a format of the collected data or a compression codec, whereby multiple users who cooperate with each other can freely use the collected data. Therefore, according to the present invention, multiple users can participate in the process of data collection, the process of software development, and the process of error correction to develop software, and can freely share the data, thereby providing a convenient and effective environment in which optimal software can be developed.

It will be apparent to those skilled in the art that various modifications and variations can be made in the present invention without departing from the spirit or scope of the inventive concept as defined by the appended claims and their equivalents.

1. A data processing device, comprising:
a sensor module collecting data by using at least one of a camera sensor, a distance sensor, a microphone array, a motion capture sensor, an environment scanner, and a haptic device;
a memory module storing and controlling the data collected by the sensor module; and
a network module transmitting the data stored in the memory module to a remote location, or receiving predetermined data from the remote location,
wherein the memory module stores the stored data and the predetermined data as data in a standardized format according to data features.

2. The device of claim 1, further comprising:
a rendering engine module calculating update data on the basis of the data stored in the memory module, in which the network module transmits the update data to the remote location.

3. The device of claim 2, wherein, when the predetermined data is a second update data generated at the remote location, the memory module overwrites the stored data with the second update data.

4. The device of claim 2, wherein the rendering engine module sends the data stored in the memory module to an output device.

5. The device of claim 1, wherein, when the predetermined data is a compressed data, the memory module decompresses the compressed data and stores the resulting data.

6. The device of claim 1, wherein the predetermined data is collected using at least one of a camera sensor, a distance sensor, a microphone array, and a haptic device provided at the remote location.

7. The device of claim 1, wherein the network module synchronizes the predetermined data and the memory module stores the synchronized data as data in a standardized format.

8. A data processing method, comprising:
collecting data by using at least one of a camera sensor, a distance sensor, a microphone array, a motion capture sensor, an environment scanner, and a haptic device;
storing the collected data in a memory module;
transmitting the stored data to a remote location or receiving predetermined data from the remote location, through a network module; and
storing the received predetermined data in the memory module,
wherein the collected data and the predetermined data are stored as data in a standardized format according to data features.

9. The method of claim 8, further comprising:
calculating update data on the basis of the data stored in the memory module using a rendering engine module; and
transmitting the update data to the remote location via the network module.

10. The method of claim 9, further comprising:
when the predetermined data is a second update data generated at the remote location, overwriting the data stored in the memory module with the second update data.

11. The method of claim 8, wherein the data stored in the memory module includes data previously received via the network module.

12. The method of claim 8, wherein the data transmitted to the remote location via the network module is a compressed data.

13. The method of claim 8, further comprising:
when the predetermined data is a compressed data, decompressing the compressed data in the memory module.

14. The method of claim 8, wherein the predetermined data is collected using at least one of a camera sensor, a distance sensor, a microphone array, and a haptic device provided at the remote location.

15. The method of claim 8, further comprising:
synchronizing the predetermined data via the network module and storing the synchronized data in the memory module as data in a standardized format.

16. A recording medium readable by a computer in which a computer program is recorded in order to perform the data processing method according to claim 8.

17. A recording medium readable by a computer in which a computer program is recorded in order to perform the data processing method according to claim 9.

18. A recording medium readable by a computer in which a computer program is recorded in order to perform the data processing method according to claim 10.

19. A recording medium readable by a computer in which a computer program is recorded in order to perform the data processing method according to claim 11.

20. A recording medium readable by a computer in which a computer program is recorded in order to perform the data processing method according to claim 12.
